(19) United States
(12) Patent Application Publication
(10) Pub. No.: US 2008/0166498 A1
(43) Pub. Date: Jul. 10, 2008

(54) METHOD OF CURING POROUS LOW-K LAYER

(75) Inventors: Mei-Ling Chen, Kaohsiung City (TW); Kuo-Chih Lai, Tainan City (TW); Su-Jen Sung, Hsinchu County (TW)

Correspondence Address: J C PATENTS, INC., 4 VENTURE, SUITE 250, IRVINE, CA, 92618, US

(73) Assignee: UNITED MICROELECTRONICS CORP., HSINCHU (TW)

(21) Appl. No.: 11/621,812

(22) Filed: Jan. 10, 2007

(51) Int. Cl. B05D 3/06

(52) U.S. Cl. 427/553

(57) ABSTRACT

A method of curing a porous low-k layer is described, which is applied to a substrate with a porous low-k layer formed thereon, wherein the porous low-k: layer contains a porogen. A first UV-curing treatment is performed to the porous low-k layer under a relatively milder condition, and then a second UV-curing treatment is performed to the porous low-k layer under a relatively harsher condition to finish the curing of the porous low-k layer.

### BACKGROUND OF THE INVENTION

1. Field of the Invention

This invention relates to an IC process. More particularly, this invention relates to a method of curing a porous low-k layer.

2. Description of Related Art

As the linewidth of IC process is reduced to the deep submicron level, the impact of RC delay effect becomes increasingly greater. One method of alleviating the RC delay effect is to reduce the parasitic capacitance, and one method of reducing the parasitic capacitance is to use low-k materials to constitute the dielectric layers of the interconnect structure.

Generally, low-k materials include organic low-k materials and porous low-k materials. A porous low-k layer is usually formed with the precursor of a porous structure framework and a porogen, and after that, the porogen is removed by a curing step to reduce the dielectric constant of the porous low-k layer.

The porous low-k layer can be cured with various methods, such as heating, UV irradiation and electron beam irradiation. In a conventional curing method, the substrate is heated to 300° C. or higher, and meanwhile UV or electron beam irradiation is performed to the porous low-k layer, wherein the treatment time is set according to the thickness of the porous low-k layer. The UV or electron beam can break the chemical bonds of the porogen molecule, and the high temperature can drive the porogen out of the porous structure.

However, the UV or electron beam irradiation may result in a substantial decrease in the thickness of the porous low-k layer and a substantial increase in the stress of the same, such that the IC process is difficult to control.

### SUMMARY OF THE INVENTION

Accordingly, this invention: provides a new method of curing a porous low-k layer, for alleviating the thickness reduction and the stress increase of the porous low-k layer caused by curing to make the control of the IC process relatively easier.

The method of curing a porous low-k layer of this invention is applied to a substrate with a porous low-k layer formed thereon, wherein the porous low-k layer contains a porogen. A first curing treatment is performed to the porous low-k layer under a relatively milder condition, and then a second curing treatment is performed to the porous low-k layer under a relatively harsher condition to finish the curing.

According to an embodiment of this invention, the first curing treatment and the second curing treatment are respectively selected from thermal treatment, electron beam treatment, UV treatment and plasma treatment. In certain embodiments, the first and the second curing treatments are of the same type, and the value of at least one parameter in-the second curing treatment is larger than that in the first curing treatment, wherein the larger the value of the parameter is, the higher energy a treatment has.

When the first and the second curing treatments are both thermal treatments, the at least one parameter is temperature. When the first and the second curing treatments are both electron beam treatments, at least one of two parameters including temperature and electron beam intensity is set higher in the second curing treatment than in the first curing treatment. When the first and the second curing treatments are both UV treatments, at least one of three parameters including temperature, UV intensity and UV wave number is set higher in the second curing treatment than in the first curing treatment. When the first and the second curing treatments are both plasma treatments, at least one of two parameters including temperature and plasma power is set higher in the second curing treatment than in the first curing treatment.

Moreover, when the first and the second curing treatments are of the same type, the value of the at least one parameter may be increased linearly with time in the first curing treatment but fixed in the second curing treatment, or be fixed in the first curing treatment but increased linearly with time in the second curing treatment, or be fixed in the first and the second curing treatments respectively but increased linearly with time in a middle stage between the first and the second curing treatments.

According to an embodiment of this invention, the porous low-k layer is formed with, for example, plasma enhanced chemical vapor deposition (PECVD) or spin-coating using a porogen. The dielectric constant “ε” of the porous low-k layer after being cured usually satisfies “1.0<ε≦2.7”. Moreover, between the first and the second curing treatments, the vacuum in the treatment chamber for performing the curing treatments may be broken or not be broken. Each curing treatment may be performed under a pressure of about 1-760 Torr, preferably about 10-400 Torr.

In certain embodiments of this invention, the first and the second curing treatments are both UV treatments, including a first and a second UV-curing treatments.

As compared with the first UV-curing treatment, the second UV-curing treatment includes at least one of a higher temperature, a higher UV intensity and a larger UV wave number. In an embodiment, at least one of the temperature, the UV intensity and the UV wave number is increased linearly with time during the first UV-curing treatment, while the condition of the second UV-curing treatment is fixed. In another embodiment, the condition of the first UV-curing treatment is fixed, but the value of at least one of the above three parameters is increased linearly with time during the second UV-curing treatment. In still another embodiment, the conditions of the first and the second UV-curing treatments are fixed respectively, but the value of at least one of the above three -parameters is increased linearly with time in a middle stage between the first and the second UV-curing treatments.

In an embodiment, as compared with the first UV-curing treatment, the second UV-curing treatment is set higher in the temperature. Preferably, the temperature (T₁) of the first UV-curing treatment is lower than 300° C. and the temperature (T₂) of the second UV-curing treatment higher than 300° C. More preferably, “150° C.<T₁≦300° C.” and “300° C.<T₂≦450° C.” are satisfied. In certain examples, the UV intensity during the first UV-curing treatment is about 20-300 mW/cm², the UV intensity during the second UV-curing treatment is about 20-300 mW/cm², the first UV-curing treatment is performed for about 1-240 minutes, and the second UV-curing treatment is performed for about 1-240 minutes. In a,preferred example, the UV intensity during the first UV-curing treatment is about 100-270 mW/cm², the UV intensity during the second UV-curing treatment is about 100-300 mW/cm², the first UV-curing treatment is performed for about 1-120 minutes, and the second UV-curing treatment is performed for about 2-60 minutes.

Moreover, the wave number of the UV light used in the UV-curing treatments may be about 2.5×10⁴ cm⁻¹ to 10⁶ cm⁻¹, preferably about 2.5×10⁴ cm⁻¹ to 5×10⁴ cm⁻¹. Between the first and the second UV-curing treatments, the vacuum in the treatment chamber for performing the UV-curing treatments may be broken or not be broken. The first and the second UV-curing treatments may be performed under a pressure of about 1-760 Torr, preferably about 10-400 Torr.

By performing the above two curing treatments of this invention to cure a porous low-k layer containing a porogen, the thickness reduction and the stress increase of the porous low-k layer caused by the curing can be alleviated, so that the control of the IC process is relatively easier.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a flow chart of a method of curing a porous low-k layer according to an embodiment of this invention.

### DESCRIPTION OF EMBODIMENTS

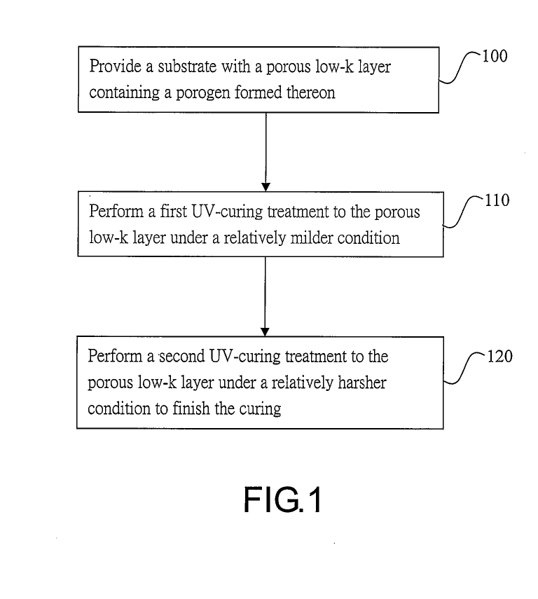

FIG. 1 is a flow chart of a method of curing a porous low-k layer according to an embodiment of this invention.

Referring to FIG. 1, first, a substrate with a porous low-k layer formed thereon is provided, wherein the porous low-k layer contains a porogen (Step 100). The porous low-k layer is formed with, for example, PECVD or spin-coating using the porogen, wherein the precursor of the porous structure framework is usually organosilicate and the porogen is usually hydrocarbon (CₓH_{y}). The dielectric constant “ε” of the porous low-k layer after being cured satisfies “1.0<ε≦2.7”. Then, a first UV-curing treatment is performed to the porous low-k layer under a relatively milder condition (Step 110), and then a second UV-curing treatment is performed to the porous low-k layer under a relatively harsher condition (Step 120) to finish the curing. In this invention, a relatively harsher/milder condition may refer to, for example, a relatively higher/lower porogen removal rate.

Here, the condition of the second UV-curing treatment being harsher than that of the first UV-curing treatment means, for example, that the second UV-curing treatment includes at least one of a higher temperature, a higher UV intensity and a larger UV wave number as compared with the first U-curing treatment. The higher the temperature is, the higher the rate of driving out the porogen will be. The higher the UV intensity or the larger the UV wave number is, the higher light energy is provided in unit time, such that more chemical bonds are broken in unit time, i.e., more porogen is decomposed into small molecules which are easy to drive out of the porous structure.

Further, the conditions of the first and the second UV-curing treatments may have the following variations. In a variation, the value of at least one of the three parameters including temperature, UV intensity and UV wave number is increased linearly with time during the first UV-curing treatment, but the condition of the second UV-curing treatment is fixed. In the second UV-curing treatment, the value of the at least one parameter whose value was increased linearly in the first UV-curing treatment may be equal to or larger than the value at the end of the first UV-curing treatment.

In another variation, the condition of the first UV-curing treatment is fixed, but the value of at least one of the above three parameters is increased linearly with time during the second UV-curing treatment. In the first UV-curing treatment, the value of the parameter whose value will be increased linearly with time in the second UV-curing treatment may be equal to or smaller than the value at the beginning of the second UV-curing treatment.

In still another variation, the conditions of the first and the second UV-curing treatments are fixed respectively, but the value of at least one of the above three parameters is increased linearly with time during a middle stage between the first and the second UV-curing treatments. At the beginning of the middle stage, the value of the parameter whose value is increased linearly during the middle stage may be equal to or larger than the value set in the first UV-curing treatment. At the end of the middle stage, the value of the parameter whose value is increased linearly during, the middle stage may be smaller than or equal to the value set in the second UV-curing treatment.

In a preferred embodiment, as compared with the first UV-curing treatment, the second UV-curing treatment is set higher in the temperature. Preferably, the, temperature (T₁) of the first UV-curing treatment is lower than 300° C. and the temperature (T₂) of the second UV-curing treatment higher than 300° C. More preferably, “150° C.≦T₁<300° C.” and “300° C.≦T₂≦450° C.” are satisfied.

In certain examples, the UV intensity during the first UV-curing treatment is about 20-300 mW/cm², the UV intensity during the second UV-curing treatment is about 20-300 mW/cm², the first UV-curing treatment is performed for about 1-240 minutes, and the second UV-curing treatment is performed for about 1-240 minutes. In a preferred example, the UV intensity during the first UV-curing treatment is about 100-270 mW/cm², and the UV intensity during the, second UV-curing treatment is about 100-300 mW/cm², the first UV-curing treatment is performed for about 1-120. minutes, and the second UV-curing treatment is performed for about 2-60 minutes.

Moreover, the wave number of the UV light used in the UV-curing treatments is about 2.5×10⁴ cm⁻¹ to 10⁶ cm⁻¹, preferably about 2.5×10⁴ cm⁻¹ to 5×10⁴ cm⁻¹. Between the first and the second UV-curing treatments, the vacuum in the treatment chamber for performing the UV-curing treatments may be broken or not be broken. The first and the second UV-curing treatments are usually performed under a pressure of about 1-760 Torr, preferably about 10-400 Torr. Moreover, during the first and the second UV-curing treatments, an oxygen-containing gas like O₂, O₃ or CO₂ gas, an inert gas like He or Ar gas, or a nitrogen-containing gas like N₂ or NH₃ gas, can be used as a treating gas. Generally, the flow rate of the treating gas is about 100-100,000 sccm, preferably about 20,000-90,000 sccm.

In some experiment examples, a dielectrics barrier with a thickness within the range of 300-500 Å and a material of SiCN is disposed under a porous low-k layer with a thickness within the range of 1000-3500 Å, a pore size within the range of 1-10 nm and CₓH_{y} (3≦x<20, 4≦x<30) as the porogen. The UV intensity in the first and the second UV-curing treatments is within the range of 140-270 mW/cm², and the wave number of the UV light is within the range of 3.3×10⁴-5×10⁴ cm⁻¹. The temperature of the first UV-curing treatment is within the range of 200-300° C., and the treating time of the same is within the range of 1-5 minutes. The temperature of the second UV-curing treatment is within the range of 350-400° C., and the treating time of the same is within the range of 1-5 minutes. It is found that in the experiment examples, as compared with the result of a conventional single UV-curing treatment, the stress increase of the porous low-k layer is alleviated by about 10% and the thickness reduction of the same alleviated by about 20%, and the stress increase of the dielectric barrier is alleviated by about 10%. and the thickness reduction of the same alleviated by about 22%.

Although the method of curing a porous low-k layer in the above embodiment includes a first UV-curing treatment under a relatively milder condition and a second UV-curing treatment under a relatively harsher condition, the scope of this invention is not limited thereto, and may include two curing treatments of other types. The first and the second curing treatments are respectively selected from thermal treatment, electron beam treatment, UV treatment and plasma treatment, wherein the case of the first and the second curing treatments both being UV treatments is the above embodiment.

In certain embodiments, the first and the second curing treatments are of the same type, and the value of at least one parameter in the second curing treatment is larger than that in the first curing treatment, wherein the larger the value of the parameter is, the higher energy a treatment has. In addition, different types of treatments have different parameters, as described below.

When the first and the second curing treatments are both thermal treatments, the at least one parameter is temperature, wherein the higher the temperature is, the higher the rate of driving out the porogen will be. Moreover, the pressure during the thermal treatments can be set as described above, and oxygen gas can be used to facilitate the decomposition of the, porogen.

When the first to second curing treatments are both electron beam treatments, at least one of two parameters including temperature and electron beam intensity is set higher in the second curing treatment than in the first one, wherein the higher the UV intensity is, the more chemical bonds are broken in unit time. Moreover, the above mentioned treatment gas may also be introduced during the electron beam irradiation.

When the first to second curing treatments are both plasma treatments, at least one of two parameters including temperature and plasma power is set higher in the second curing treatment than in the first one, wherein the higher the plasma power is, the higher the decomposition rate of the porogen is. The treating gas used during the plasma treatment preferably contains oxygen to facilitate decomposition of the porogen.

Furthermore, when the first and the second curing treatments are of the same type, the value of the at least one parameter may be increased linearly with time in the first curing treatment but fixed in the second curing treatment, wherein the fixed value is equal to or larger than the value of the parameter at the end of the first curing treatment. The value of the parameter may alternatively be fixed in the first curing treatment but increased linearly with time in the second curing treatment from a value equal to or larger than the fixed value. The value of the parameter may alternatively be fixed in the first and the second curing treatments respectively but increased linearly with time in a middle stage between the first and the second curing treatments, wherein the value of the parameter at the beginning of the middle stage is equal to or larger than the fixed value in the first curing treatment, and that at the end of the middle stage is smaller than or equal to the fixed value in the second curing treatment.

By performing the above two curing treatments of this invention, to cure a porous low-k layer containing a porogen, the thickness reduction and stress increase of the porous low-k layer caused by the curing can be alleviated, so that the control of the IC process is relatively easier.

The present invention has been disclosed above in the preferred embodiments, but is not limited to those. It is known to persons skilled in the art that some modifications and innovations may be made without departing from the spirit and scope of the present invention. Therefore, the scope of the present invention should be defined by the following claims.

What is claimed is:

1. A method of curing a porous low-k layer, applied to a substrate with a porous low-k layer formed thereon, wherein the porous low-k layer contains a porogen, the method comprising:
performing a first UV-curing treatment to the porous low-k layer under a relatively milder condition; and
performing a second UV-curing treatment to the porous low-k layer under a relatively harsher condition to finish the curing.

2. The method of claim 1, wherein as compared with the first UV-curing treatment, the condition of the second UV-curing treatment comprises at least one of a higher temperature, a higher UV intensity and a larger UV wave number.

3. The method of claim 2, wherein during the first UV-curing treatment, at least one of the temperature, the UV intensity and the UV wave number is increased linearly with time, while the condition of the second UV-curing treatment is fixed.

4. The method of claim 2, wherein the condition of the first UV-curing treatment is fixed, while during the second UV-curing treatment, at least one of the temperature, the UV intensity and the UV wave number is increased linearly with time.

5. The method of claim 2, wherein the conditions of the first and the second UV-curing treatments are respectively fixed, the method further comprising a middle stage between the first and the second UV-curing treatments, in which at least one of the temperature, the UV intensity and the UV wave number is increased linearly with time.

6. The method of claim 1, wherein as compared with the first UV-curing treatment, the second UV-curing treatment is set higher in temperature.

7. The method of claim 6, wherein the temperature (T₁) of the first UV-curing treatment is lower than 300° C., and the temperature (T₂) of the second UV-curing treatment is higher than 300° C.

8. The method of claim 7, wherein “150° C.≦T₁<300° C.” and “300° C.<T₂≦450° C.” are satisfied.

9. The method of claim 8, wherein a UV intensity during the first UV-curing treatment is about 20-300 mW/cm², a UV intensity during the second UV-curing treatment is about 20-300 mW/cm², the first UV-curing treatment is performed for about 1-240 minutes, and the second UV-curing treatment is performed for about 1-240 minutes.

10. The method of claim 9, wherein the W intensity during the first UV-curing treatment is about 100-270 mW/cm², the UV intensity during the second UV-curing treatment is about 100-300 mW/cm², the first UV-curing treatment is performed for about 1-120 minutes, and the second UV-curing treatment is performed for about 2-60 minutes.

11. The method of claim 1, wherein a wave number of UV light used in the first and the second UV-curing treatments is about 2.5×10⁴ cm⁻¹ to 10⁶ cm⁻¹.

12. The method of claim 11, wherein the wave number is about 2.5×10⁴ cm⁻¹ to 5×10⁴ cm⁻¹.

13. The method of claim 1, wherein the porous low-k layer is formed with plasma enhanced chemical vapor deposition (PECVD) or spin-coating using the porogen.

14. The method of claim 1, wherein a dielectric constant “ε” of the porous low-k layer after being cured satisfies “1.0<ε≦2.7”.

15. The method of claim 1, wherein the first and the second UV-curing treatments are performed in a treatment chamber in a vacuum, and between the first and the second UV-curing treatments, the vacuum is broken or is not broken.

16. The method of claim 1, wherein the first and the second UV-curing treatments are performed under a pressure of about 1-760 Torr.

17. The method of claim 16, wherein the first and the second UV-curing treatments are performed under a pressure of about 10-400 Torr.

18. A method of curing a porous low-k layer, applied to a substrate with a porous. low-k layer formed thereon, wherein the porous low-k layer contains a porogen, the method comprising:
performing a first curing treatment to the porous low-k layer under a relatively milder condition; and
performing a second curing treatment to the porous low-k layer under a relatively harsher condition to finish the curing.

19. The method of claim 18, wherein the first and the second curing treatments are respectively selected from thermal treatment, electron beam treatment, UV treatment and plasma treatment.

20. The method of claim 19, wherein the first and the second curing treatments are of the same type, the value of at least one parameter in the second curing treatment is higher than that in the first curing treatment, and the larger the value of the parameter is, the higher energy a treatment has.

21. The method of claim 20, wherein the first and the second curing treatments are both thermal treatments, and the at least one parameter is temperature.

22. The method of claim 20, wherein the first and the second curing treatments are both electron beam treatments, and at least one of two parameters including temperature and electron beam intensity is set higher in the second curing treatment than in the first curing treatment.

23. The method of claim 20, wherein the first and the second curing treatments are both UV treatments, and at least one of three parameters including temperature, UV intensity and UV wave number is set higher in the second curing treatment than in the first curing treatment.

24. The method of claim 20, wherein the first and the second curing treatments are both plasma treatments, and at least one of two parameters including temperature and plasma power is set higher in the second curing treatment than in the first curing treatment.

25. The method of claim 20, wherein the value of the parameter is increased linearly with time in the first curing treatment, but is fixed in the second curing treatment.

26. The method of claim 20, wherein the value of the parameter is fixed in the first curing treatment, but is increased linearly with time in the second curing treatment.

27. The method of claim 20, wherein the value of the parameter is fixed in the first and the second curing treatments, the method further comprising a middle stage between the first and the second curing treatments, in which the value of the parameter is increased linearly with time.

28. The method of claim 18, wherein the porous low-k layer is formed with PECVD or spin-coating using the porogen.

29. The method of claim 18, wherein a dielectric constant “ε” of the porous low-k layer after being cured satisfies “1.0<ε≦2.7”.

30. The method of claim 18, wherein the first and the second curing treatments are performed in a treatment chamber in a vacuum, and between the first and the second curing treatments, the vacuum is broken or is not broken.

31. The method of claim 18, wherein a pressure during the first and the second curing treatments is about 1-760 Torr.

32. The-method of claim 31, wherein the pressure is about 10-400 Torr.
